(19) United States
(12) Patent Application Publication
(10) Pub. No.: US 2022/0051230 A1
(43) Pub. Date: Feb. 17, 2022

(54) CRYPTOCURRENCY TRANSACTION SYSTEM

(71) Applicant: CoolBitX Ltd., Grand Cayman (KY)

(72) Inventors: Jay ZHUANG, Taipei City (TW); Shih-Mai OU, Taipei City (TW)

(73) Assignee: CoolBitX Ltd., Grand Cayman (KY)

(21) Appl. No.: 16/992,858

(22) Filed: Aug. 13, 2020

(51) Int. Cl. G06Q 20/36; G06Q 20/38

(52) U.S. Cl. CPC G06Q 20/3674; G06Q 20/38215; G06Q 20/3825; G06Q 20/3829; G06Q 20/3823

(57) ABSTRACT

The present invention comprises an electronic carrier and an electronic device. The electronic carrier comprises a microprocessor and a security chip stored with a transaction authorizing key and a transaction confirmation program. The electronic device is installed with a transaction application applicable to a plurality of cryptocurrencies. The transaction application is stored with a plurality of scripts and can generate a transaction request after receiving a cryptocurrency balance through a networking module. The transaction request includes a raw data that is incapable of being executed independently and a target script. The electronic carrier generates a transaction authorization data according to the target script and the raw data, and the transaction authorization data is transferred to the cloud transaction platform for completing the transaction of cryptocurrency. Therefore, the electronic carrier is applicable to various released cryptocurrency types, and the loading of electronic carrier is reduced.

### FIELD OF THE DISCLOSURE

The present disclosure relates to a transaction system that uses electronic carrier to authorize the transfer of cryptocurrency, and more particularly, to a transaction system that can be applied in known cryptocurrency formats and applicable to new currency formats released in the future.

### BACKGROUND

The so-called blockchain technology is a kind of distributed ledger technology that does not rely on third parties and uses its own distributed nodes to store, verify, transmit and communicate network data. It apply multiple computing devices to participate together and jointly maintain a complete distributed database, where anyone can use the same technical standards to add their own information therein at any time, and extend the blockchain to continuously satisfy the data establishment needs brought by various requirement.

Because blockchain technology has the advantages such as decentralization, openness and transparency, all computing devices must participate in database recording, and data synchronization among computing devices. Therefore, the decentralized system technology of blockchain has been widely used in many fields.

The most common blockchain technology is used in transactions of cryptocurrency, such as Bitcoin, Ethereum, Litecoin, Ripple. It runs on a decentralized blockchain network in a peer-to-peer (P2P) manner, and the entire transaction process is completed anonymously. It does not rely on the issuance and maintenance of a central institution, but supports the trustworthiness of transaction through the blockchain network.

The current cryptocurrency transaction protocols are all based on network technology and cryptography. The access and writing of the protocol are related to the private key, public key and address. The private key is a random string generated randomly, the public key is generated by encrypting the private key through elliptic curve cryptography, and the address is calculated from the public key to reduce the number of bits of the public key that the recipient needs to mark.

The method that can record the private key can be a wallet, and it can be divided into cold wallet and hot wallet according to whether it is directly exposed to the Internet. Generally the cold wallets can could be such as paper, USB flash drives, optical discs, memory cards, electronic carrier capable of be operated (such as electronic cards), etc.; while the hot wallets could be such as computer client wallets, mobile phone APP wallets, web wallets.

In order to prevent the digital assets of cryptocurrency from being trespassed by hackers, most users use electronic carriers of cold wallet, and the electronic carrier has additional verification mechanisms to reduce phishing or deception. However, given that the types of cryptocurrency continue to evolve and the constitution of various currency types is different, it often causes the load of verification mechanism in the electronic carrier to increase continuously. In addition, most of the electronic carriers have a fixed number of verification methods that has been set when the manufacturing is completed, and cannot add or update additional verification methods that will limit the use of electronic carriers.

### SUMMARY

The main purpose of the present invention is to provide a transaction system that combines an electronic carrier and an electronic device, so that the transaction application installed on the electronic device can pre-determine the type of cryptocurrency, so that the electronic carrier can directly perform displaying, composing and authorization operations of transaction requirements without a built-in analysis module. Accordingly, the electronic carrier is applicable to various cryptocurrency types that have been released currently, and the load of the electronic carrier is reduced.

The secondary purpose of the present invention is to enable the electronic carrier to authorize transactions of various cryptocurrencies newly released in the future without additional updates or installation of other programs, thereby greatly increasing the application range of the transaction system.

Another purpose of the present invention is to have an additional verification mechanism between the electronic carrier and the electronic device, so that unauthorized packet data cannot be executed by the electronic carrier, thereby enhancing the security of the transaction system.

To achieve the above purpose, the cryptocurrency transaction system of the present invention includes an electronic carrier and an electronic device. The electronic carrier has a security chip, a display screen, an operation interface, a transmission module to make pairing connection, and a microprocessor. The security chip stores a transaction authorizing key and a transaction confirmation program.

The electronic device is installed with a transaction application applicable to multiple cryptocurrencies, and makes pairing connection with the transmission module of the electronic carrier. The transaction application stores a plurality of scripts that one-to-one match the cryptocurrency formats. The transaction application receives a cryptocurrency balance of a cloud account book via a networking module. One of the formats of the cryptocurrency will be selected by the transaction application to generate a transaction request. The transaction request includes a raw data that cannot be independently executed by the transaction confirmation program and a target script matching the format of the cryptocurrency. The transaction application then transmits the target script and the raw data to the microprocessor of the electronic carrier.

The transaction confirmation program calculates the raw data according to the target script to generate a transaction detail for displaying on the display screen and a transaction data; when the transaction confirmation program receives a confirmation instruction generated by the operation interface, the transaction data will be combined with the transaction authorizing key to generate a transaction authorization data, and the transaction authorization data will then be transmitted to the transaction application through the transmission module; the transaction application transmits the transaction authorization data to a cloud transaction platform comprising the cloud account book to complete the cryptocurrency transaction.

In one preferred embodiment, the transaction application further stores a pairing public key and a pairing private key, and a pairing signature is generated by the pairing private key, and the pairing signature is transmitted to the security chip for storage when the electronic device makes pairing connection with the electronic carrier. The scripts and the target script all have an authorization code that can be verified by the transaction confirmation program. The target script, the raw data, and the paring signature are integrated by the transaction application into a data packet that is transmitted to the electronic carrier.

In addition, the transaction confirmation program has an authentication module and a calculation module. The calculation module is restricted by the authentication module to a locked state where the calculation is suspended, and the authorization code and the pairing signature of the target script would be verified by the authentication module, so that the calculation module is shifted into an unlocked state that can calculate the raw data according to the target script.

The transaction application comprises a database module and a transaction requesting module. The database module stores a plurality of scripts that one-to-one match the cryptocurrency formats, and the database module can update and store other scripts to add additional cryptocurrency formats; one of the scripts will be selected by the transaction requesting module to be the target script to match the assigned cryptocurrency format.

The target script comprises a display instruction and a composing instruction. A plurality of display data are generated distributedly from the chosen part of the raw data according to the display instruction, and the transaction details are composed of the display data. A plurality of composing data are generated distributedly from all the raw data according to the composing instruction, and the transaction data are composed of the combination of the composing data and a main body.

As can be seen from above description, the feature of the present invention is that t the type of cryptocurrency can be chosen by the transaction application of the electronic device, the target scrip can be combined with the raw data that from calculating the transaction-related data, so that the electronic carrier not need a built-in analysis module and directly uses the target script to calculate raw data, accordingly to directly perform displaying, composing and authorization operations of transaction requirements. Through it, the electronic carrier is applicable to various cryptocurrency types that have been released currently, and the load of the electronic carrier is reduced.

### BRIEF DESCRIPTION OF THE DRAWINGS

FIG. 1 is a schematic illustrating cryptocurrency transaction system of the present invention;

FIG. 2 is a schematic illustrating the internal structure of the electronic device;

FIG. 3 is a schematic illustrating the transaction application adding and storing other scripts;

FIG. 4 is a schematic illustrating the internal structure of the electronic carrier;

FIG. 5 is a schematic illustrating the pairing connection between the electronic device and the electronic carrier;

FIG. 6 is a schematic illustrating the electronic device obtaining a cryptocurrency balance from a cloud account book;

FIG. 7 is a schematic illustrating the transaction confirmation program for transaction confirmation and date calculation;

FIG. 8 is a schematic illustrating two kinds calculation performed by the script;

FIG. 9 is a schematic illustrating the electronic carrier receiving the confirmation instruction to complete the authorization signature; and

FIG. 10 is a schematic illustrating the electronic device obtaining authorization to conduct cryptocurrency transactions.

### DETAILED DESCRIPTION OF PREFERRED EMBODIMENTS

In order to further understand the structure, usage and features of the present disclosure more clearly, the present disclosure is described in detail below with references to the accompanying drawings and specific preferred embodiments.

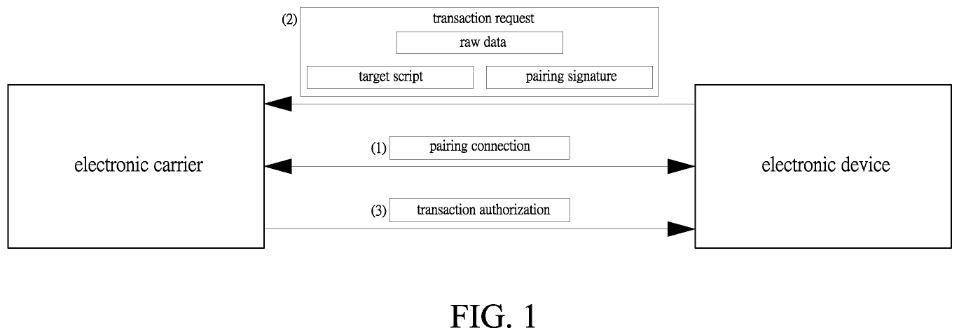

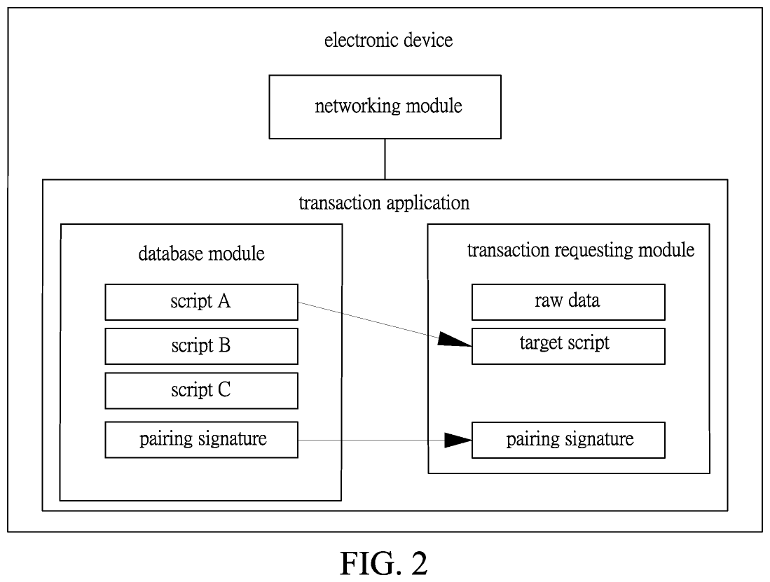

Please refer to FIG. 1. The cryptocurrency transaction system of the present invention includes an electronic carrier used as a cold wallet (such as a smart card) and an electronic device (such as a mobile phone, a tablet, a laptop) that can connect to the Internet. As shown in FIG. 2, the electronic device has a networking module that can connect to the Internet and a transaction application that is adapted for making transactions with multiple cryptocurrencies (such as Bitcoin, Ethereum, Litecoin, and the like.). In addition, the networking module can make pairing connection with the electronic carrier, and the transaction application comprises a database module and a transaction requesting module.

The database module stores a plurality of scripts that one-to-one match the cryptocurrency formats. In addition, the transaction requesting module can select one of a plurality of scripts as the target script matching the cryptocurrency, and the transaction requesting module can calculate to generate original data (raw data) that cannot be independently determined to execute. The selection of the scripts is based on the type of cryptocurrency inputted in the transaction application by a user to determine the target script, and the raw data is generated according to the transaction-related data inputted by the user.

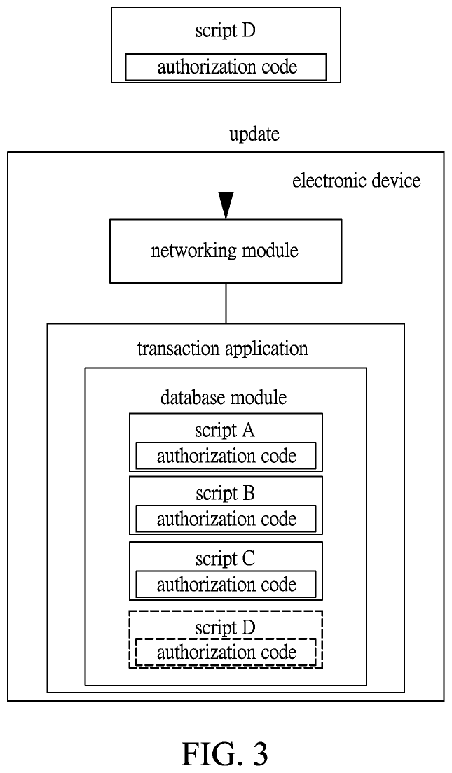

In addition, as shown in FIG. 3, if the database module initially stores only the scripts corresponding to three different cryptocurrency types, the transaction application can still be updated later to enable the database module to add forth, fifth and even sixth script.

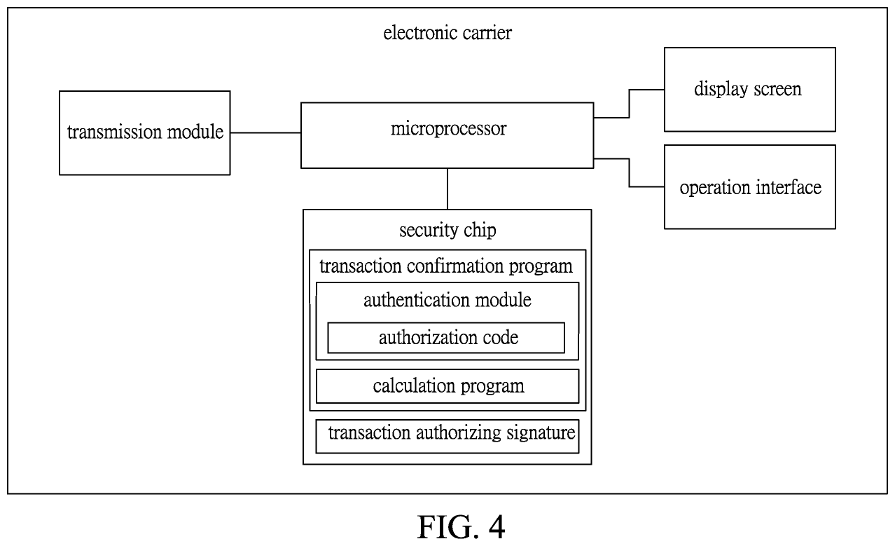

Please refer to FIG. 4. The electronic carrier includes a security chip, a display screen, an operation interface, a transmission module and a microprocessor. The security chip is used to store a transaction authorizing key and a transaction confirmation program, and the transaction confirmation program has an authentication module and a calculation module. The display screen is used to display related data such as pairing request and transaction confirmation, and the operation interface is for users to manually operate the pairing and confirmation procedures. The transmission module is used to pair the networking module for connecting the electronic device, and the microprocessor is electrically connected between the security chip, the display screen, the operation interface, and the transmission module.

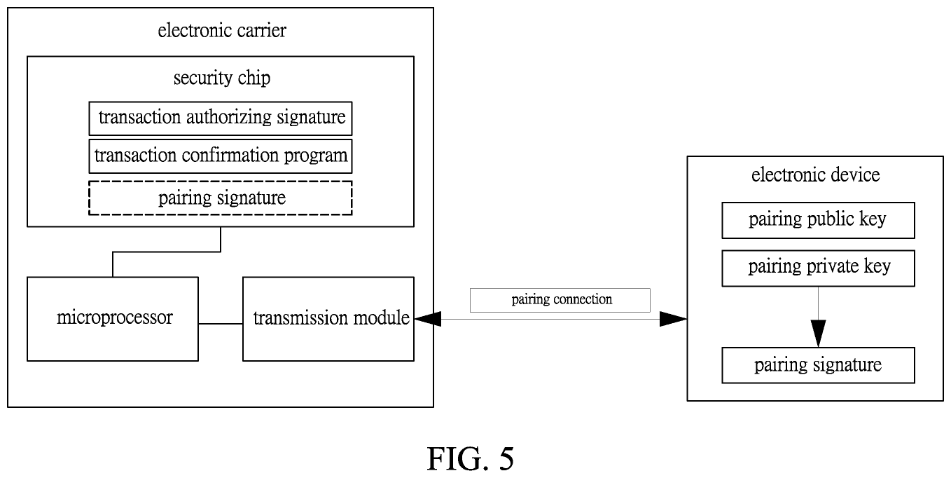

Please refer to FIG. 5. When the electronic device connects to the transmission module of the electronic carrier through the networking module to make a pairing request, the electronic carrier will detect whether a pairing public key for arbitrary electronic device is internally stored in the security chips; if there is no pairing public key, the electronic carrier will request the electronic device to provide a pairing public key, when the transaction confirmation program is completely installed on the electronic device, a pairing public key and a pairing private key are already stored therein, and accordingly, the pairing public key will be directly transferred to and stored in the security chip of the electronic carrier. However, if the security chip already stores a pairing public key, the electronic carrier will directly request the electronic device to generate a pairing signature calculated from the pairing private key, so as to increase the security of data transmission between the electronic device and the electronic carrier.

Furthermore, in order to increase the security of data transmission, the transaction application of the electronic device, the transaction confirmation program of the electronic carrier, and each script that meets the characteristics of each cryptocurrency must be developed by the same company, so that they can mutually confirm the source of program data. Therefore, the scripts must comprise an authorization code (as shown in FIG. 3). The authorization code can be stored in both of the transaction application and the transaction confirmation program.

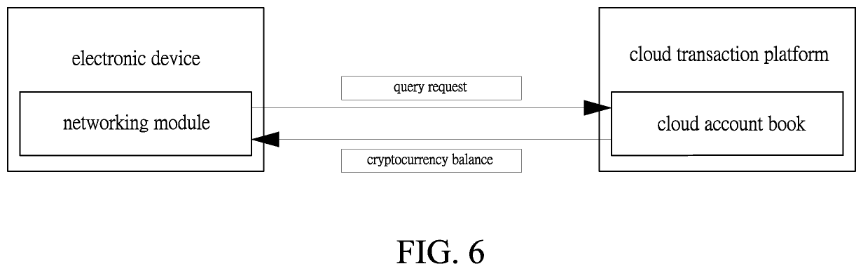

Please refer to FIG. 6. When making a cryptocurrency transaction, first the user must confirm the status of the cryptocurrency of oneself through the transaction application, so that the networking module sends a query request to a cloud account book of a cloud transaction platform. The cloud account book transmits a corresponding cryptocurrency balance to the transaction application according to the query request, allowing the transaction application to display the cryptocurrency balance to the user.

Please refer to FIG. 1 again. After obtaining the cryptocurrency balance, the user can select the cryptocurrency type to be traded, and input the transaction object and transaction amount that allows the transaction application to select the corresponding one of cryptocurrency types from the scripts to be the target script. The transaction requesting module calculates out the raw data according to data such as the transaction object, transaction amount, and cryptocurrency type. The transaction requesting module will then integrate the target script, the raw data, and the pairing signature into one data packet, and the data packet will be transmitted to the electronic carrier by the networking module.

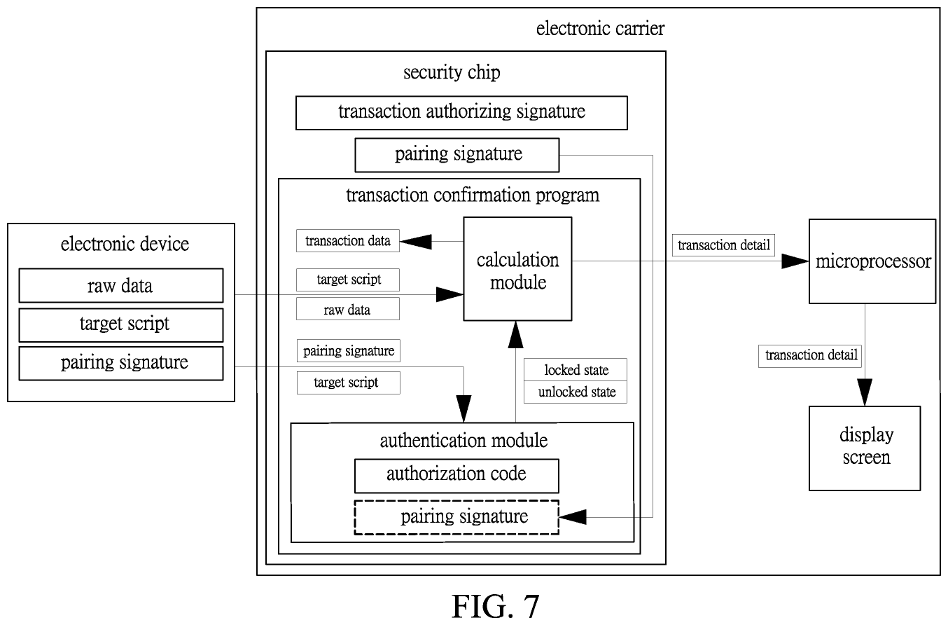

Please refer to FIG. 7. The authentication module of the transaction confirmation program restricts the calculation module to a locked state where the calculation is suspended. Therefore, when the electronic carrier receives the data packet, the authorization code of the target script and the pairing signature are obtained by the authentication module. The authentication module will perform verification by two different verified data; subsequently, the calculation module will be shifted by the authentication module into an unlocked state capable of calculating.

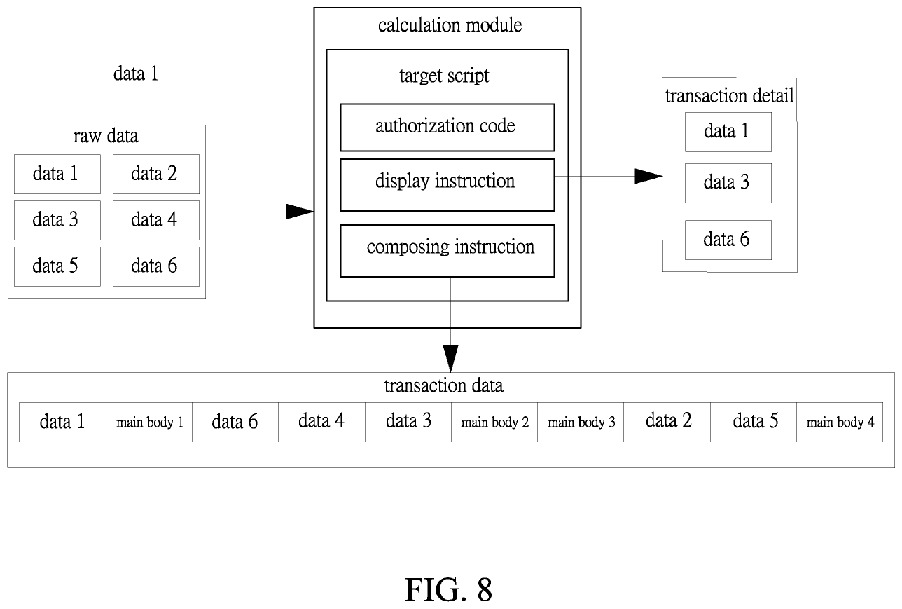

Please refer to FIG. 8. In the unlocked state, the calculation module will calculate the raw data according to the target script, and thus generate a transaction detail and transaction data displayed on the display screen; in one preferred embodiment, in addition to the authorization code, the target script also comprises a display instruction and a composing instruction. The display instruction is to distributedly extract part of the raw data into a plurality of display data, and the display data constitute the transaction details; the composing instruction is to distributedly extract all the raw data into a plurality of composing data, and combine the composing data in main body data to jointly constitute the transaction data.

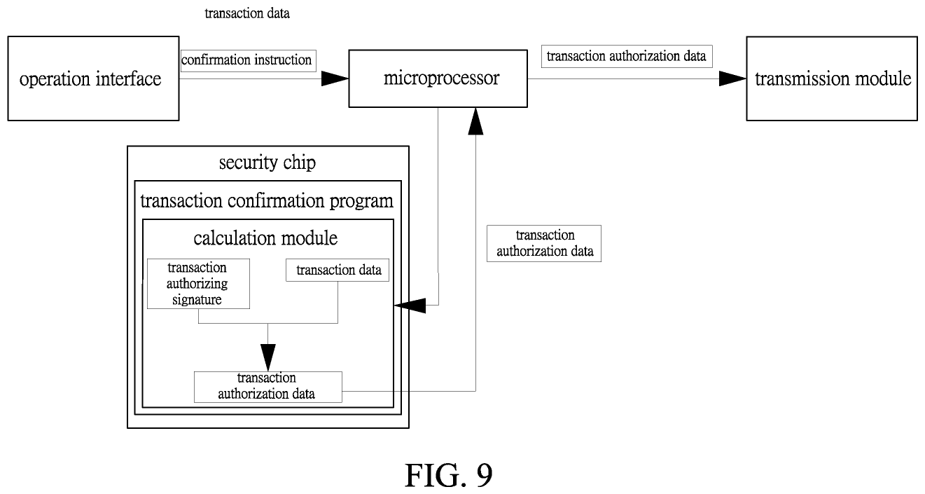

Please refer to FIG. 9. Later, the user can know the content of the transaction details through the display screen and confirm whether the transaction details are consistent with the details initially inputted on the electronic device. After the confirmation, the transaction confirmation program will then receive a confirmation instruction generated by the operation interface, and the calculation module will again combine the transaction data with the transaction authorizing key to generate transaction authorization data.

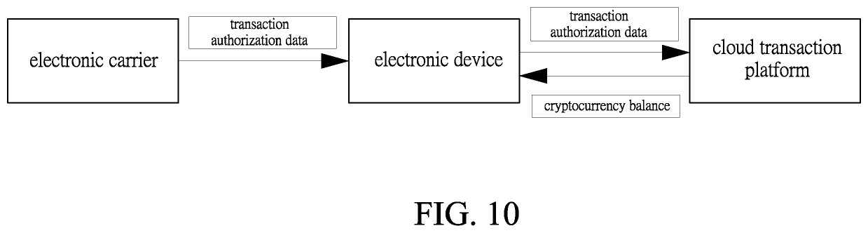

Please refer to FIG. 10. Finally, the transaction authorization data is transmitted to the transaction application through the transmission module; then the transaction application transmits the transaction authorization data to the cloud transaction platform through the networking module. The cloud transaction platform will complete the cryptocurrency transaction according to the transaction object, transaction amount and cryptocurrency type in the transaction authorization data, and transmits the cryptocurrency balance to the electronic device for display after the transaction is completed.

What is claimed is:

1. A cryptocurrency transaction system, comprising
an electronic carrier, having a security chip, a display screen, an operation interface, a transmission module to make pairing connection, and a microprocessor, the security chip stores a transaction authorizing key and a transaction confirmation program;
an electronic device, installed with a transaction application applicable to a plurality of cryptocurrencies, and making pairing connection with the transmission module of the electronic carrier, the transaction application stores a plurality of scripts that one-to-one match the cryptocurrency formats, and the transaction application receives a cryptocurrency balance of a cloud account book via a networking module, and one of the formats of the cryptocurrency will be selected by the transaction application to generate a transaction request, the transaction request includes a raw data that cannot be independently executed by the transaction confirmation program and a target script matching the format of the cryptocurrency, and then the transaction application transmits the target script and the raw data to the microprocessor of the electronic carrier;
wherein the transaction confirmation program calculates the raw data according to the target script to generate a transaction detail for displaying on the display screen and a transaction data;
wherein when the transaction confirmation program receives a confirmation instruction generated by the operation interface, the transaction data will be combined with the transaction authorizing key to generate a transaction authorization data, and the transaction authorization data will then be transmitted to the transaction application through the transmission module; and
wherein the transaction application transmits the transaction authorization data to a cloud transaction platform comprising the cloud account book to complete the cryptocurrency transaction.

2. The cryptocurrency transaction system according to claim 1, wherein the transaction application further stores a pairing public key and a pairing private key, and a pairing signature is generated by the pairing private key, and the pairing signature is transmitted to the security chip for storage when the electronic device makes pairing connection with the electronic carrier; the scripts and the target script all have an authorization code that can be verified by the transaction confirmation program.

3. The cryptocurrency transaction system according to claim 2, wherein the target script, the raw data, and the paring signature are integrated by the transaction application into a data packet that is transmitted to the electronic carrier.

4. The cryptocurrency transaction system according to claim 3, wherein the transaction confirmation program has an authentication module and a calculation module, the calculation module is restricted by the authentication module to a locked state where the calculation is suspended, and the authorization code and the pairing signature of the target script would be verified by the authentication module, so that the calculation module is shifted into an unlocked state that can calculate the raw data according to the target script.

5. The cryptocurrency transaction system according to claim 1, wherein the transaction application comprises a database module and a transaction requesting module;
the database module stores a plurality of scripts that one-to-one match the cryptocurrency formats, and the database module can update and store other scripts to add additional cryptocurrency formats; and
wherein one of the scripts will be selected by the transaction requesting module to be the target script to match the assigned cryptocurrency format.

6. The cryptocurrency transaction system according to claim 1, wherein the target script comprises a display instruction and a composing instruction,
a plurality of display data are generated distributedly from the chosen part of the raw data according to the display instruction, and the transaction details are composed of the display data; and
a plurality of composing data are generated distributedly from all the raw data according to the composing instruction, and the transaction data are composed of the combination of the composing data and a main body.
